(19) United States
(12) Patent Application Publication
(10) Pub. No.: US 2012/0203391 A1
(43) Pub. Date: Aug. 9, 2012

(54) NETWORK SYSTEM AND METHOD OF CONTROLLING THE SAME

(76) Inventor: Sangsu Lee, Seoul (KR)

(21) Appl. No.: 13/502,010

(22) PCT Filed: Nov. 3, 2010
(86) PCT No.: PCT/KR2010/007720

§ 371 Date: Apr. 13, 2012

(30) Foreign Application Priority Data
Nov. 4, 2009 (KR) 10-2009-0105839

(51) Int. Cl. G06F 1/28; G06F 1/32

(52) U.S. Cl. 700/295

(57) ABSTRACT

Provided is a network system that includes an advanced metering infrastructure and an energy management system. The advanced metering infrastructure communicates with a power supply source and measures energy supplied from the power supply source. The energy management system is connected to the advanced metering infrastructure to communicate with it and controls an operation of an electric product based on information about the operation of the electric product or energy information supplied from the power supply source. A normal mode operated based on setting by a user, and a saving mode for saving power consumption or an electricity charge based on the energy information are defined in the electric product or the energy management system. The using of an electric product in a time period where an electricity charge per time is a predetermined reference or greater is suppressed, or the operation thereof is delayed to save an electricity charge.

### TECHNICAL FIELD

The present disclosure relates to a network system and a method of controlling the network system.

### BACKGROUND ART

In general, power for operating electric products such as electric home appliances or office equipment is supplied through a power plant, a power transmission line, and a power distribution line.

Such power is supplied from a central power source, not a distributed power source, so that the power spreads in a radial shape from the center to the periphery, which is supplier-centered rather than consumer-centered. In addition, the supplying of the power is analog and electromechanical, and damage due to an accident is manually undone, and related facilities are manually recovered.

The information about electricity charge can be known only through a power exchange, and thus, it is difficult to know the information about electricity charge in real time. In addition, since a pricing system is substantially fixed, it is difficult to provide incentives for consumers by using price variations. To address these limitations and improve the efficiency of energy, research is being actively carried out on a smart grid.

The smart grid means the next generation power system and a management system thereof, which are realized by mixing and combining a modernized power technology and an information communication technology. A typical power grid is vertical and centralized network that is controlled by a supplier, but the smart grid is a horizontal, cooperative, and distributed network that is distributed from a supplier and allows the interaction between suppliers and consumers.

In the smart grid, all electric appliances, power storage devices, and distributed power sources are connected to one another through a network, so that suppliers can interact with consumers. Thus, the smart grid is referred to as an ‘energy Internet’. To realize the smart grid for power consumers such as a house or a building, it is needed that a separate electric product and a network connected to a plurality of electric products communicate with a power supply source through a two-way communication for power information, instead of just receiving power. Also, devices for the two-way communication are needed.

### DISCLOSURE OF INVENTION

### Technical Problem

Embodiments provide a network system and a method of controlling the network system, which suppress the using of an electric product in a time period where an electricity charge is high, to save an electricity charge.

Embodiments also provide a network system and a method of controlling the network system, which reduce the amount of power consumed when a predetermined electric product is operated according to a mode originally set by a user.

### Solution to Problem

In one embodiment, a network system includes: an advanced metering infrastructure communicating with a power supply source and measuring energy supplied from the power supply source; and an energy management system connected to the advanced metering infrastructure to communicate with the advanced metering infrastructure and controlling an operation of the electric product based on information about the operation of an electric product or energy information supplied from the power supply source, wherein a normal mode operated based on setting by a user, and a saving mode for saving power consumption or an electricity charge of the electric product based on the energy information are defined in the electric product or the energy management system.

In another embodiment, a network system includes: an advanced metering infrastructure communicating with a power supply source and measuring energy supplied from the power supply source; and an energy management system connected to the advanced metering infrastructure to communicate with the advanced metering infrastructure and controlling an operation of an electric product based on information about the operation of the electric product or energy information including information about an electricity charge that is a set reference or greater, wherein the electric product or the energy management system includes a plurality control modes that controls: an original set mode operated based on setting by a user; and a saving mode to save power consumption or an electricity charge of the electric product based on the energy information.

In further another embodiment, a method of controlling a network system includes: selecting one of a normal mode in which an electric product is operated based on setting by a user, and a saving mode in which power consumption or an electricity charge of the electric product is decreased based on energy information; and selecting, when the saving mode is selected, one of a selection control mode in which information about the power consumption or the electricity charge is displayed, and a forced control mode that is driven in a manner of decreasing the power consumption or the electricity charge.

The details of one or more embodiments are set forth in the accompanying drawings and the description below. Other features will be apparent from the description and drawings, and from the claims.

### Advantageous Effects of Invention

According to the embodiment, the using of an electric product in a time period where an electricity charge per time is a predetermined reference or greater is suppressed, or the operation thereof is delayed to save an electricity charge.

In addition, the electric product is operated in the energy saving mode or the electricity charge saving mode based on the original set state mode set by a user, to save the energy and costs.

### BRIEF DESCRIPTION OF DRAWINGS

FIG. 1 is a schematic view illustrating a smart grid according to an embodiment.

FIG. 2 is a schematic view illustrating a network system according to an embodiment.

FIG. 3 is a front view illustrating an energy management system (EMS) according to an embodiment.

FIG. 4 is a block diagram illustrating a control of a network system according to an embodiment.

FIG. 5 is a block diagram illustrating a control of a network system according to another embodiment.

FIGS. 6 to 8 are flowcharts illustrating a method of controlling a network system according to an embodiment.

FIG. 9 is a graph illustrating variations in a power consumption amount and an electricity charge with time.

### MODE FOR THE INVENTION

Reference will now be made in detail to the embodiments of the present disclosure, examples of which are illustrated in the accompanying drawings.

All terms used herein have the same meanings as general terms understood by those of ordinary skill in the art. If the terms used herein collide with the general terms, the terms used herein take priority over the general terms. While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

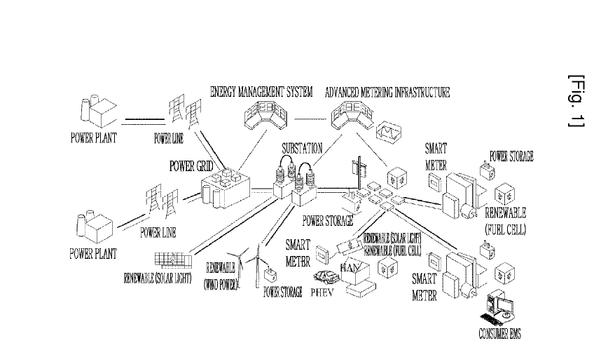

FIG. 1 is a schematic view illustrating a smart grid according to an embodiment.

Referring to FIG. 1, the smart grid includes a power plant generating energy (electricity) by thermal power generation, nuclear power generation, or water power generation; and a solar power plant and a wind power plant that generate electricity from renewable energy sources such as solar light and wind power.

The power plant, such as a thermal power plant, a nuclear power plant, and a water power plant, supplies electricity to a sub-control center through a power line, and the sub-control center supplies the electricity to a substation where the electricity is distributed to consumers such as residential customers or offices.

Electricity generated from renewable energy sources is delivered to the substation where the electricity is distributed to consumers. Electricity transmitted from the substation is distributed to consumers such as offices and residential customers through power storages.

Residential customers using a home area network (HAN) may produce electricity by using a solar battery or fuel cells of a plug in hybrid electric vehicle (PHEV) for their own use or selling the remaining electricity.

Energy generated from the power plant, renewable energy, or in-house energy may be referred to as an ‘energy supply source’.

In addition, since smart metering devices are provided to consumers such as offices or residential customers, power consumption or electricity bills can be checked in real time, and thus the consumers can take action to reduce power consumption or electricity costs based on the real-time information about power consumption and electricity bills.

Furthermore, since the power plants, the sub-control center, the power storages, and the consumers can communicate with each other (two-way communication), electricity is not transmitted to the consumers unilaterally but generated and distributed to the consumers according to the consumers' situations notified to the power storages, the sub-control center, and the power plants.

In such a smart grid, an energy management system (EMS) plays a pivotal role for real-time power line communication with a consumer, and an advanced metering infrastructure (AMI) plays a pivotal role for real-time power consumption measurement.

The AMI of the smart grid is backbone technology for integrating consumers based on an open architecture. The AMI provides consumers with the ability to use electricity efficiently and power providers with the ability to detect problems on their systems and operate them efficiently.

Herein, the open architecture means a standard for connecting all electric products in a smart grid system regardless of the manufactures of the electric products, unlike in a general communication network. Therefore, the AMI of the smart grid enables consumer-friendly efficiency concepts like “prices to devices.”

That is, real-time price information of an electricity market may be displayed on an EMS of each residential customer, and the EMS may control electric products while communicating with the electric products. Thus, a user may see the information displayed on the EMS to check energy (power) information of each electric product and carry out power information processing such as power consumption limit setting or electricity charge limit setting to save energy and reduce costs.

The EMS may include local EMSs provided in offices or residential customers, and a central EMS configured to process information collected from the local EMSs through two-way communication.

Since real-time communication is possible between providers and consumers in a smart grid for exchanging power information, real-time grid response can be realized, and costs necessary for meeting a peak demand can be reduced.

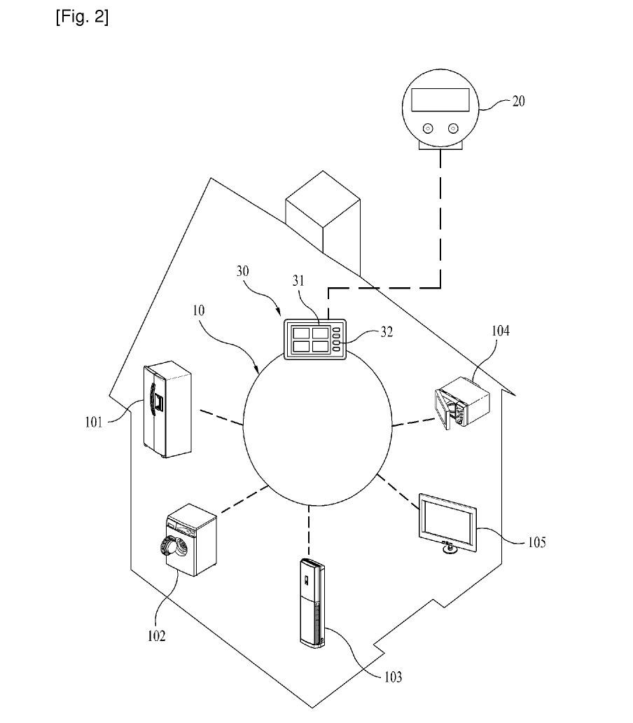

FIG. 2 is a schematic view illustrating a network system according to an embodiment, in which the network system is a power supply network system 10 of a residential customer as a main consumer of power.

The power supply network system 10 includes: an advanced metering infrastructure (smart meter) 20 which can measure power supplied to a residential customer and the electricity charge of the power in real time; and an energy management system (EMS) 30 connected to the advanced metering infrastructure (smart meter) 20 and a plurality of electric products such as home appliances for controlling the electric products.

For example, the electricity charge is measured based on a charge per time. The charge per time is high in a time period where power consumption increases steeply and low in a time period such as midnight where a relatively small amount of power is consumed.

The EMS 30 may be provided in the form of a terminal, which includes a screen 31 to display the current power consumption state and external environments (temperature, humidity) and an input unit 32 to receive user's manipulations.

The EMS 30 is connected to an electric product 100 such as a refrigerator 101, a washing or drying machine 102, an air conditioner 103, a TV 105, and a cooking appliance 104 through an in-house network for two-way communication.

In-house communication may be performed by wireless or power line communication (PLC), and electric home appliances may be connected to each other for communicating with each other.

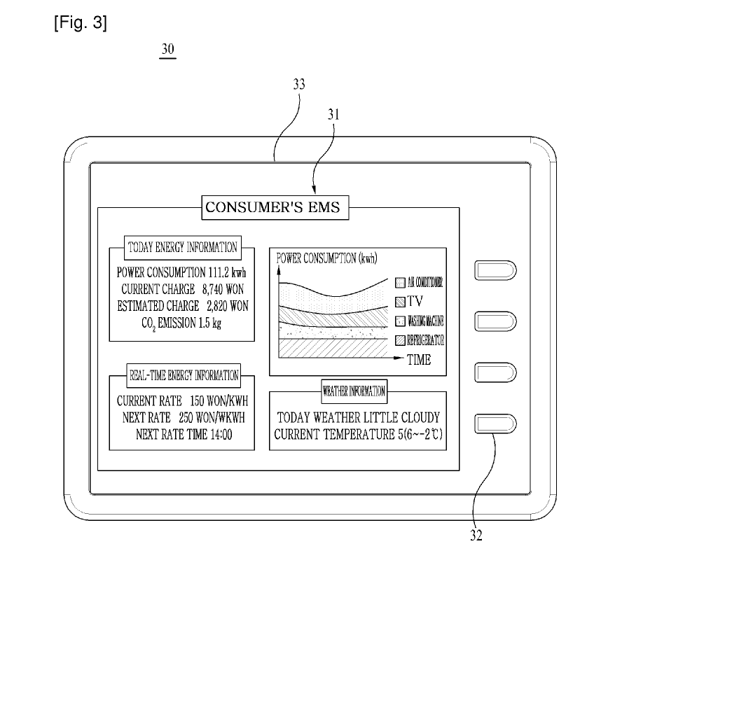

FIG. 3 is a front view illustrating an energy management system (EMS) according to an embodiment. Referring to FIG. 3, the EMS may be a terminal including a touch panel 33.

A screen 31 may be displayed on the touch panel 33 to provide energy information such as an electricity consumption amount, an electricity charge, an electricity charge estimated based on an accumulated consumption history, and a carbon dioxide emission amount; and/or additional information such as weather information.

The electricity consumption amount or the electricity charge may be provided as real time information, accumulated information, or current time period information or the next time period information within a preset time period.

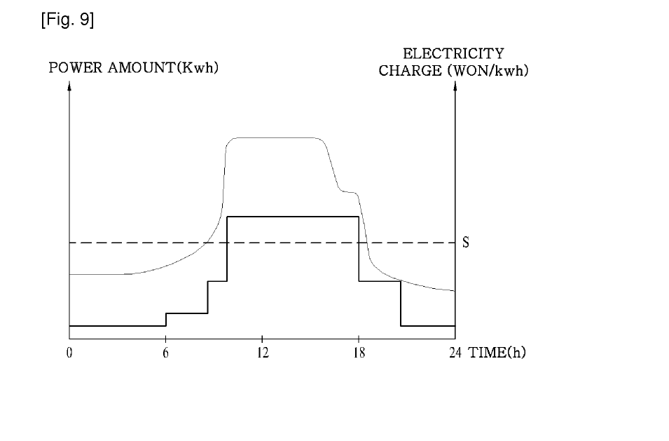

The screen 31 may include a graph illustrating power consumption amounts and variations thereof according to time periods of each electric product. For example, the screen 31 may display an electricity charge variation graph according to time periods illustrated in FIG. 9.

A button part 32 may be disposed at a side of the screen 31 to set an operation of an electric product according to a user's requirement.

A user uses 32 uses the button part 32 to set a limit of a power amount or an electricity charge of each electric home appliance, and thus, the EMS 30 can control the operation of each electric home appliance according to the setting.

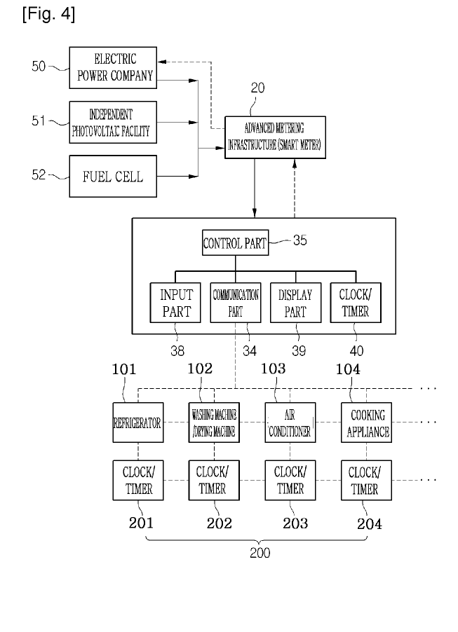

FIG. 4 is a block diagram illustrating a control of a power supply source under a smart grid, and a control of a network system that is in charge of supplying power to an electric product in home.

Referring to FIG. 4, the power supply source may an electric power company 50 including typical generating equipment (thermal power, nuclear power, and water power) or generating equipment using renewable energy (solar light, wind power, and terrestrial heat). In addition, the power supply source may include an independent photovoltaic facility 51 that can be provided to each residential customer, and a fuel cell 52 that can be provided to a fuel cell vehicle or a residential customer. The power supply source is connected to the advanced metering infrastructure (smart meter) 20, and the advanced metering infrastructure 20 is connected to the EMS 30.

The EMS 30 may include a control part 35, an input part 38, a communication part 34, a display part 39, and a clock/timer 40.

The communication part 34 communicates with an electric home appliance such as a refrigerator 101, a washing/drying machine 102, an air conditioner 103, and a cooking appliance 104 to transmit and receive power information and driving information thereof.

The control part 35 analyzes set information input by a user using the input part 38, previously accumulated history information about the operation of electric products and power usage, and the amount of power supplied from the outside, and controls the operations and power of the electric products based on the information. The display part 39 displays power information supplied from the power supply source, and operation information or power information of an electric product.

The EMS 30 controls the operation of the electric product, particularly, provides an electricity charge saving mode for saving an electricity charge during the operation of an electric product, and an energy saving mode for saving consumption power. The electricity charge saving mode operates based on information about an electricity charge varied according to an operation time of an electric product. The electricity charge saving mode and the energy saving mode may be referred to as ‘a saving mode’, compared to an original set mode (normal mode) to be described later.

The control part 35 uses the clock/timer 40 to determine whether a present time period is a time period (i.e., first time period) where an electricity charge is over a predetermined reference or a time period (i.e., second time period) where an electricity charge is the predetermined reference or less.

When the clock/timer 40 determines that a present time is within the first time period, the clock/timer 40 may provide a time for reaching the second time period.

When a user sets an operation of a predetermined electric product to use the electric product according to an original set mode (a mode operated by a user without considering saving of an electricity charge or energy, that is, the normal mode), the EMS 30 determines whether a present time is within the first time period or the second time period. A result of the determining is the second time period, the electric product operates according to the original set mode.

On the contrary, it is determined that the present time is within the first time period, it is displayed that an electricity charge per time at the present time is over a predetermined reference, and information about the second time period for saving the electricity charge is provided.

In detail, information about a time for reaching the second time period and information about an electricity charge that can be saved if the electric product is operated according to the original set mode within the second time period are provided. That is, a so-called ‘selection control mode’ is provided in which predetermined information is provided and the electric product is operated in the electricity charge saving mode according to the user's selection.

However, the user may manipulate the EMS 30 to omit a guide to the second time period, so that if the present time is within the first time period, the operation of the electric product according to the original set mode can be delayed until the first time period is ended. As such, the case in which the operation of the electric product is forcibly controlled when the present time is within the first time period may be referred to as a ‘forced control mode’.

That is, to address the case in which a user such as a child, a young person, or a man who does not sensitive to an electricity charge uses the electric product, a user such as a housewife who is sensitive to an electricity charge presets the forced control mode.

For example, when the electric product is a washing machine, and a user selects an old stain washing course at a time that is disposed within the first time period, if the selection control mode that requires a large amount of washing water and much operation time is set, information about the second time period and a remaining time thereof are provided to the user, so that the user can perform the washing machine according to the information and the remaining time.

On the contrary, if the forced control mode is set, operations of the washing machine are delayed until reaching the second time period, or the rest of the operations except for main operations is stopped. That is, supplying of washing water or a detergent may be performed, but steam may be generated within the second time period.

For example, when the electric product is a drying machine, if the selection control mode is set and the present time is within the first time period, information about the second time period is provided, so that the drying machine can be operated according to a user's selection.

On the contrary, if the forced control mode is set and the present time is within the first time period, a drying heater is stopped until reaching the second time period, or the amount of heat emitted from the drying heater is decreased to a predetermined level or less. Then, when the second time period is recognized, the drying machine operates in an original set mode (normal mode set by the user).

The energy saving mode is a saving mode in which an equivalent effect to a technical effect obtained in an original set mode that is originally (at the start) set by a user is obtained but power consumption can be reduced. The energy saving mode may be proposed to a user (selection control mode), or be forcibly performed (forced control mode).

For example, when the electric product is a washing or drying machine, and a drying method (e.g., course) set by a user is a standard operation method (course), if the amount of water stored in the washing or drying machine is small and the water is light-weighted, a quick operation mode that consumes less power than the standard operation mode (course) and quickly washes or dries a laundry may be performed.

In this case, the amount of washing water or a washing time is less than in the standard operation mode. In the drying machine, a drying time and the amount of heat emitted from the heater are less than in the standard operation mode.

When the selection control mode is set in the energy saving mode, information about operation courses related with the energy saving mode is provided to a user, so that the user can select an appropriated operation course.

On the contrary, when the forced control mode is set, the washing or drying machine is forcibly switched to the energy saving mode and is operated.

As illustrated in FIG. 4, the energy saving mode or the electricity charge saving mode may be controlled by the EMS 30 that is provided independently from the electric product.

Alternatively, the EMS 30 may be removably attached to an electric product, or an electric product may function as the EMS 30.

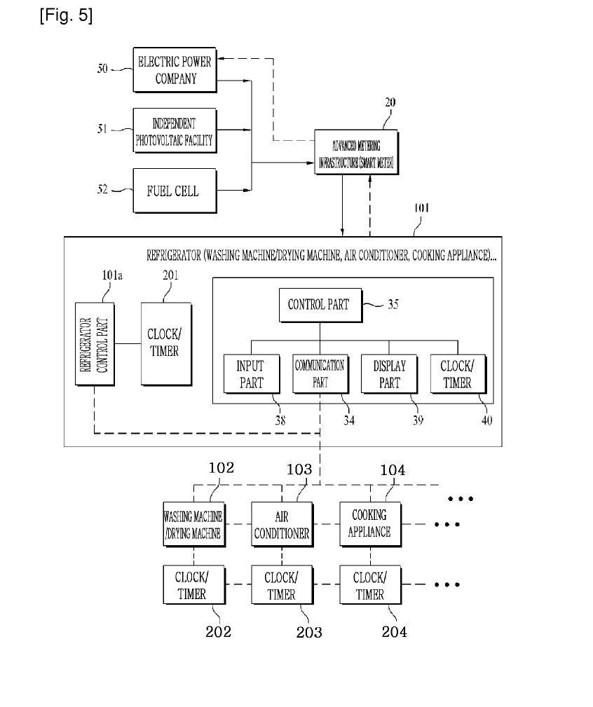

That is, as illustrated in FIG. 5, the EMS 30 may be removably attached to an electric product such as the refrigerator 101 that operates for 24 hours. Alternatively, the EMS 30 may be installed on an air conditioner or a washing/drying machine. That is, the EMS 30 is compatible with a plurality of electric products.

As a result, the EMS 30 can control each electric product. The EMS 30 may perform the energy saving mode or the electricity charge saving mode, corresponding to the function of one of a plurality of electric products.

The control part 35, the communication part 34, the input part 38, and the display part 39 may be provided to the EMS 30, separately from a control part 101a of the electric product. Operation signals or power information of a plurality of electric products may be recognized or processed by the EMS 30.

Since the EMS 30 is the same in operation and function as that of FIG. 4 except for the position of the EMS 30, a description thereof will be omitted.

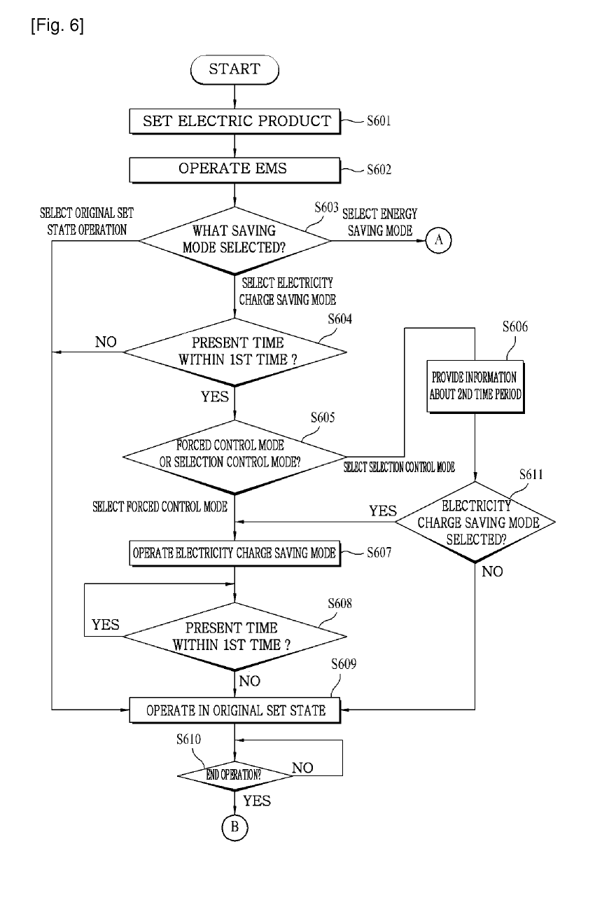

Hereinafter, an operation of a network system according to an embodiment will now be described with reference to the accompanying drawings. FIGS. 6 to 8 are flowcharts illustrating a method of controlling a network system according to an embodiment.

As illustrated in FIG. 6, a user performs a predetermined setting operation in operation S601 on an EMS or an electric product such as a washing machine, a drying machine, or a refrigerator to operate the electric product, and the EMS is operated in operation S602.

At this point, the EMS may be provided independently from the electric product to function as a separate terminal communicating with the electric product, or be integrally formed with the electric product as a function of the electric product.

In this state, it is determined in operation S603 what mode is selected from the energy saving mode, the electricity charge saving mode, and an original set state (normal mode) that is originally set by the user. When the original set state operation is set, the electric product is operated according to the original set state operation in operation S609.

When the electricity charge saving mode is selected, it is determined in operation S604 whether the present time is within a first time period in which an electricity charge per time is over a predetermined reference. If the present time is not within the first time period, the electric product is operated in the original set state (normal mode).

In the graph as illustrated in FIG. 9, the first time period is a time period in which an electricity charge depicted with a thick solid line is a predetermined reference S or greater.

If the present time is within the first time period, it is determined in operation S605 whether the selected one is the selection control mode in which the electric product is operated according to the user's selection, or the forced control mode in which the electricity charge saving mode is performed regardless of the user's selection.

If the forced control mode is selected, the electricity charge saving mode is performed regardless of the user's selection in operation S607. When the electricity charge saving mode is performed, the electric product is prevented, for the first time period, from operating in the original set state that is originally set by the user. That is, if the electric product is in operation, the electric product is stopped or operated in a state with a smaller power consumption amount than an original one.

During the electricity charge saving mode, it is continually checked whether the present time is within the first time period. In this state, when it is determined that the present time reaches the second time period where the electricity charge is not more than the predetermined reference S (refer to FIG. 9) out of the first time period, the electric product is operated in the original set state (normal mode) in operation S609.

When the user selects the selection control mode in operation S605, information about the second time period is provided in operation S606. That is, a time for reaching the second time period, information about an electricity charge within the second time period, or an electricity charge difference between the first and second time periods is provided to help the user reasonably select the electricity charge saving mode.

In the state where the present time is within the first time period, when the electricity charge saving mode is selected again in operation S611, the electric product starts to operate according to the electricity charge saving mode. That is, one of the operation modes of the electric product may be selected through the selection control mode, and then, be switched to the forced control mode.

That is, if the user determines, based on the information received in operation S606, that selecting of the electricity charge saving mode within the first time period is economical, or that it is unnecessary for the electric product to operate at the present time, the user may select the electricity charge saving mode to save the electricity charge.

If the user does not select the electricity charge saving mode even when the user is informed of the second time period and power charge information thereof, the electric product is operated in operation S609 in the original set state (normal mode) that is originally set by the user.

As illustrated in FIG. 7, when the energy saving mode is selected in operation S603, it is checked in operation S701 whether a saving course requiring less power consumption than that of the course set by the user is present.

For example, when the user puts a small amount of a washing or drying target into the washing or drying machine and selects a standard operation course, it may be determined that the target may be processed in a quick operation course instead of the standard operation course. At this point, the standard operation course is the set course, and the quick operation course is the saving course.

A set value for determining whether the saving course is selectively performed according to the users' intention or is forcibly performed regardless of the users' intention is checked in operation S702. When the forced control mode is selected, the energy saving mode is performed. That is, the standard operation course is switched to the quick operation course in operation S704.

If the user selects the return to the set course, the electric product operates according to the set course. That is, the quick operation course is switched back to the standard operation course in operations 705 and S707.

When the user selects the selection control mode in operation S702, information about the saving mode is provided. That is, information about a total operation time, power consumption, a saved power amount, or an electricity charge according to the saving mode is provided in operation S703.

When the user selects the energy saving mode, the electric product operates according to the energy saving mode. When the user does not select the energy saving mode although the information about the energy saving mode is provided, the electric product operates according to the set course in operation S707.

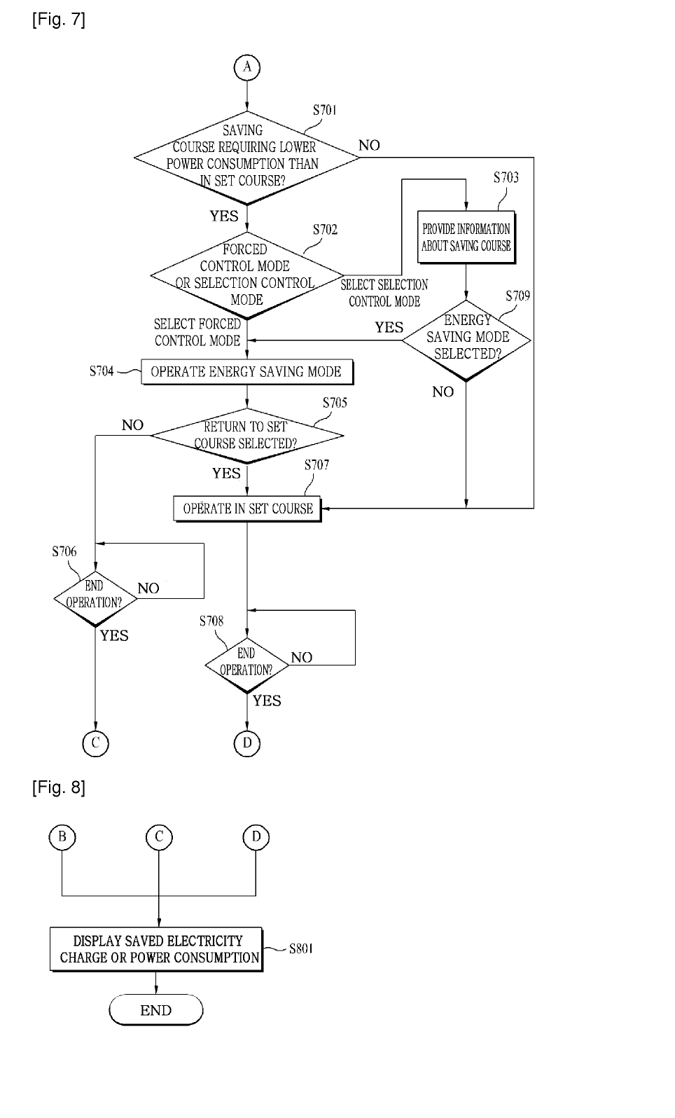

As illustrated in FIGS. 6 and 7, when the operation in the original set mode (normal mode), the energy saving mode, or the electricity charge saving mode is stopped in operations S610, S706, and S708, a saved electricity charge or saved power consumption is displayed on the EMS or the electric product as illustrated in FIG. 8.

Thus, the user can easily recognize an electricity charge or a power consumption amount, which can be saved when the energy saving mode or the electricity charge saving mode is performed.

FIG. 9 is a graph illustrating the first and second time periods and the reference S that separates the first and second time periods from each other. Since a power consumption amount is larger within the first time period where an electricity charge per time is the reference S or greater than within the other periods, the electricity charge quickly increases within the first time period according to the law of demand and supply.

Since the power consumption amount is smaller within the second time period, the electricity charge is low. Thus, it is economical to the user that power is consumed in the second time period instead of consuming power in the first time period.

The reference separating the first and second time periods is varied according to the variation of the reference S, and the rate of change of a total power consumption amount curve (thin solid line) and the rate of change of an electricity charge curve (thick solid line) may be varied according to the variation of the reference S.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The network system according to the embodiment suppresses the using of an electric product in a time period where an electricity charge per time is a predetermined reference or greater, or delays the operation thereof to save an electricity charge.

1. A network system comprising:
an advanced metering infrastructure communicating with a power supply source and measuring energy supplied from the power supply source; and
an energy management system connected to the advanced metering infrastructure to communicate with the advanced metering infrastructure and controlling an operation of an electric product based on information about the operation of the electric product or energy information supplied from the power supply source,
wherein a normal mode operated based on setting by a user, and a saving mode for saving power consumption or an electricity charge of the electric product based on the energy information are defined in the electric product or the energy management system.

2. The network system according to claim 1, wherein the saving mode comprises;
an energy saving mode for decreasing the power consumption of the electric product; and
an electricity charge saving mode for decreasing the electricity charge according to driving of the electric product.

3. The network system according to claim 2, wherein the energy saving mode is performed according to whether a saving course requiring less power consumption than that of a set driving method is present.

4. The network system according to claim 2, wherein in the electricity charge saving mode, the electric product is operated in a period where the electricity charge is relatively low, based on the energy information.

5. The network system according to claim 1, wherein the normal mode and the saving mode are allowed to be switched to each other.

6. The network system according to claim 5, wherein the normal mode and the saving mode are switched to each other by the user's selection.

7. The network system according to claim 1, wherein the saving mode is selectively performed according to a selection control mode or a forced control mode.

8. The network system according to claim 7, wherein in the selection control mode, information for reducing the power consumption or the electricity charge of the electric product is displayed to provide a reference for selecting the saving mode.

9. The network system according to claim 8, wherein consumption power or an electricity charge in the normal mode and consumption power or an electricity charge in the saving mode are displayed in the selection control mode such that the consumption power or the electricity charge in the normal mode is compared with the consumption power or the electricity charge in the saving mode.

10. The network system according to claim 7, wherein a driving method is determined and performed in the forced control mode to reduce the power consumption or the electricity charge of the electric product.

11. The network system according to claim 7, wherein the selection control mode and the forced control mode are allowed to be switched to each other.

12. The network system according to claim 11, wherein when the saving mode is selected while the selection control mode is performed, the electric product performs the saving mode according to the forced control mode.

13. A network system comprising:
an advanced metering infrastructure communicating with a power supply source and measuring energy supplied from the power supply source; and
an energy management system connected to the advanced metering infrastructure to communicate with the advanced metering infrastructure and controlling an operation of an electric product based on information about the operation of the electric product or energy information including information about an electricity charge that is a set reference or greater,
wherein the electric product or the energy management system includes a plurality control modes that controls: an original set mode operated based on setting by a user; and a saving mode to save power consumption or an electricity charge of the electric product based on the energy information.

14. The network system according to claim 13, wherein the control modes comprises a selection control mode in which information about the power consumption or the electricity charge is displayed to select whether the saving mode is performed; and
a forced control mode in which the saving mode is forcibly performed to save the power consumption or the electricity charge.

15. The network system according to claim 14, wherein consumption power or an electricity charge in the original set mode and consumption power or an electricity charge in the saving mode are displayed in the selection control mode such that the consumption power or the electricity charge in the original set mode is compared with the consumption power or the electricity charge in the saving mode.

16. The network system according to claim 14, wherein in the forced control mode, the saving mode is performed according to whether a driving method for decreasing the power consumption is present or whether a time period where the electricity charge is relatively low is present.

17. The network system according to claim 13, wherein the saving mode comprises:
an electricity charge saving mode for saving the electricity charge; and
an energy saving mode for decreasing the power consumption.

18. The network system according to claim 17, wherein in the electricity charge saving mode, driving of the electric product is controlled out of a time period where the electricity charge is the set reference or greater.

19. The network system according to claim 17, wherein in the energy saving mode, a driving method requiring less energy than that of a driving method performed in the original set mode is proposed or forcibly performed according to whether the driving method is present.

20. A method of controlling a network system, the method comprising:
selecting one of a normal mode in which an electric product is operated based on setting by a user, and a saving mode in which power consumption or an electricity charge of the electric product is decreased based on energy information; and
selecting, when the saving mode is selected, one of a selection control mode in which information about the power consumption or the electricity charge is displayed, and a forced control mode that is driven in a manner of decreasing the power consumption or the electricity charge.

21. The method according to claim 20, wherein the saving mode comprises:
an energy saving mode that is driven to decrease the power consumption of the electric product; and
an electricity charge saving mode that is driven to decrease the electricity charge according to driving of the electric product.

22. The method according to claim 21, further comprising, when the saving mode is the energy saving mode, determining whether a driving method requiring less power consumption than that of a driving method set by the user is present.

23. The method according to claim 21, further comprising, when the saving mode is the electricity charge saving mode, determining whether a present time period is within a time period where the electricity charge is higher than a set reference.

24. The method according to claim 20, wherein when the normal mode is selected, the electric product is driven in an original set state set by the user.

25. The method according to claim 20, wherein when the selection control mode is selected, information about a first time period where the electricity charge is a set reference or greater, and information about a second time period where the electricity charge is lower than a set reference are displayed.

26. The method according to claim 20, wherein when the selection control mode is selected, a saving course in which power consumption is less than that of a set course set by the user is proposed.

27. The method according to claim 20, wherein when the forced control mode is selected, a time period where the electricity charge is low, or a saving course where the power consumption is low is selected to drive the electric product.
